(19) United States
(12) Patent Application Publication
(10) Pub. No.: US 2026/0221792 A1
(43) Pub. Date: Jul. 30, 2026

(54) BATTERY CHARGING STATION

(71) Applicant: Armorgard Limited, Fareham Hampshire (GB)

(72) Inventors: Matthew Partridge, Fareham Hampshire (GB); Thomas Hayward, Fareham Hampshire (GB); Damien Taylor, Fareham Hampshire (GB)

(21) Appl. No.: 19/145,275

(22) PCT Filed: Jan. 16, 2024
(86) PCT No.: PCT/GB2024/050114

§ 371 Date: Jul. 2, 2025

(30) Foreign Application Priority Data
Jan. 31, 2023 (GB) 2301393.1

(51) Int. Cl. H02J 7/70; A62C 3/16; G08B 21/18; H01M 10/46; H01M 10/48; H01M 50/204; H01M 50/24; H01M 50/247; H01M 50/383; H02J 7/50

(52) U.S. Cl. CPC H02J 7/751; A62C 3/16; G08B 21/182; H01M 10/46; H01M 10/482; H01M 10/486; H01M 50/204; H01M 50/24; H01M 50/247; H01M 50/383; H02J 7/50; H01M 2220/30

(57) ABSTRACT

A mobile battery charging and storage station for both indoor and outdoor use, comprising: a weatherproof, secure cabinet mounted on wheels and having a width less than 800 mm, a plurality of internal storage units within the cabinet, each having an internal mains power supply socket and a unit air vent, each storage unit sized to receive a battery pack to be charged from the power supply socket, wherein the cabinet has an externally mounted weatherproof mains hook up socket electrically connected to supply each of the internal mains power supply sockets, and wherein the cabinet houses an automatic climate monitoring and adjusting system for supplying air to the storage units via their respective unit air vents to optimise the climate of the storage units for the charging of batteries therein.

### BACKGROUND

When working outdoors, the use of battery-powered tools has become prevalent in recent years and there has arisen a desire to be able to charge batteries and battery-powered devices near to work locations. However, leaving items to be charged in more remote locations presents a range of issues such as the security of the items. Further, there may be difficulties associated with the outdoor environment when charging batteries. The present inventors have therefore sought to improve the operation of batteries kept in a wide range of environments.

### SUMMARY OF THE INVENTION

According to a first aspect of the invention, there is provided a mobile battery charging and storage station for both indoor and outdoor use, comprising: a weatherproof, secure cabinet mounted on wheels and having a width of less than 800 mm, a plurality of internal storage units within the cabinet, each having an internal mains power supply socket and a unit air vent, each storage unit sized to receive a battery pack to be charged from the power supply socket, wherein the cabinet has an externally mounted weatherproof mains hook up socket electrically connected to supply each of the internal mains power supply sockets, and wherein the cabinet houses an automatic climate monitoring and adjusting system for supplying air to the storage units via their respective unit air vents to optimise the climate of the storage units for the charging of batteries therein.

Such a storage station may be suitable for both indoor and outdoor use by being weatherproof such that water ingress into the battery compartments due to, e.g. rain is inhibited. Further, it is desirable for the cabinet to be portable so that it can be moved near to workstations as needed. To this extent, the cabinet is mounted on wheels, which may make it easier to move the cabinet, such as by pushing, as opposed to the cabinet needing to be lifted. The automatic climate monitoring and adjusting system may supply air to the storage units based on a detected parameter of the charging station in the region of the battery.

The width is the minor horizontal dimension of the station, perpendicular to an intended direction of travel of the cabinet. The horizontal dimension of the cabinet in the direction of travel may be referred to as the length, and the width may be less than the length. The direction of travel may be a direction toward a side on which a handle for the cabinet is located. By having a width of less than 800 mm, the station may fit through doorways and may be moved around a construction site or work site more easily.

Optimising the climate of the storage units may comprise adjusting the temperature and/or humidity of air in the storage units by the air supplied by the automatic climate monitoring and adjusting system.

By providing a plurality of internal storage units within the cabinet, the security of batteries and devices located within the cabinet may be improved by allowing aplurality of users to store and charge their batteries and devices separately.

Each of the internal storage units is provided with an air vent. The air supply flow direction to the storage units may be either from ambient or to ambient via the air vent. Ambient air from external to the cabinet may be supplied into the internal storage units via the air vent under forced airflow action by the automatic climate monitoring and adjusting system. For example the automatic climate monitoring and adjusting system may comprise a fan to draw ambient air through the air vents into internal storage units.

Alternatively, air from the automatic climate monitoring adjusting system may be supplied into the internal storage units and then exhausted to ambient from the air vents.

Each of the internal storage units may have their climate controlled centrally by the automatic climate monitoring and adjusting system. Alternatively, each of the internal storage units may have their climate controlled individually by the automatic climate monitoring and adjusting system. Further alternatively, groups of the internal storage units may have their climate controlled individually by the automatic climate monitoring and adjusting system.

The mains hook up socket is a socket arranged to receive electrical power for transferring to each of the power supply sockets of the internal storage units. By providing a weatherproof socket, the prospect of power interruption due to rain or other environmental issues is reduced.

Each of the internal storage units may have a moveable closure for selectively preventing access to the respective internal storage unit. This may improve the security of the internal storage units by preventing the tampering of batteries and devices within the units and preventing unauthorised removal of the contents of the units.

Each closure may have a closure vent to allow a throughflow of air via the unit air vent, the internal storage unit and the closure vent. In this way, air may be passed through the separate internal storage units in parallel by the climate monitoring and adjusting system. This may be preferable to situations where the air flows through the units in series, in which case the air temperature may be affected by preceding units before entering subsequent units. Further, the arrangement of the units to receive air flow in parallel may allow improved thermal isolation between the contents of each unit, reducing the prospect of catastrophic thermal runaway due to malfunction of a battery or device.

The automatic climate monitoring and adjusting system may have a fan for drawing ambient air through the internal storage units in parallel.

The mobile battery charging and storage station may further comprise a smoke sensor adjacent an exhaust from the fan for detecting smoke from within any one of the internal storage units.

Each closure may be lockable. By providing a lock on each closure, the security of the contents of the internal storage units may be improved further.

The cabinet may further comprise a general closure, the general closure arranged to prevent access to all of the internal storage units. In the case where a plurality of users may store belongings in the internal storage units and may all be away for a period of time, a general closure may provide a further degree of security to the station.

The general closure may further comprise a general vent for allowing air flow between the plurality of internal storage units and the environment external to the cabinet. This may allow improved climate control of the internal storage units by allowing a higher flow rate of air through the internal storage units by the automatic climate monitoring and adjusting system.

The general vent may have a rain cover for reducing the ingress of water into the general vent. The presence of a rain cover may improve weatherproofing of the cabinet and may reduce the prospect of damage occurring to batteries or electrical short circuiting due to ingress of water.

The mobile battery charging storage station may further comprise a general switch arranged to selectively allow electrical communication between the mains hook up socket and the power supply sockets of the internal storage units. The general switch may act as an emergency shut off and may prevent or reduce damage in the case of a short circuit or other electrical malfunction.

The mobile battery charging and storage station may further comprise a reserve power supply coupled to the automatic climate monitoring and adjusting system. The general switch may be configured to isolate power to the power supply sockets of the internal storage units, and/or the reserve power supply may be configured to activate a fan of the automatic climate monitoring and adjusting system to draw ambient air through the internal storage units, when a fire is detected within the mobile battery charging and storage station.

The automatic climate monitoring and adjusting system may be arranged to selectively increase or decrease the temperature of the air in the storage unit. The automatic climate monitoring and adjusting system may increase the temperature of the air in the internal storage units and the automatic climate monitoring and adjusting system may decrease the temperature of the air in the internal storage units. In order for batteries to function optimally, their temperature should be controlled. Where batteries may become excessively cold, such as outside during winter, the voltage provided by the batteries may be too low to run equipment. This is often misinterpreted by users as the battery being discharged and so is addressed incorrectly by continuing to charge the battery.

The present inventors have realised that a low temperature may cause sub-optimal performance of batteries and that overall energy efficiency may be improved by providing a heating system. Alternatively, batteries may overheat in some circumstances, such as when they are in a well-insulated indoor environment or outdoors during summer. In particular, this presents a problem for lithium-ion batteries as the batteries are prone to run away heating due to short circuiting at high temperatures. The cooling of the internal storage units may thereby provide a safer charging and storage station.

The station may have a sounder for sounding when the climate of the storage units exceeds predetermined limits

The station may have a weight of less than 400 kg, or less than 300 kg, or less than 200 kg, or less than 100 kg. This may allow the station to be more portable.

The station may have wheels and/or may have a handle. This may improve the portability of the station.

The station may further comprise a fire suppression and/or extinguishing system.

The mobile battery charging and storage station may further comprise a global system for mobile (GSM) module for communicating with a building's fire suppression and/or extinguishing system so as to activate the building fire suppression and/or extinguishing system when the GSM module is activated, such as upon detection of a fire within the mobile battery charging and storage station.

According to a second aspect of the invention, there is provided a method of charging a battery comprising: placing a battery inside a charging station; coupling the battering to an electrical connection to charge the battery; detecting a parameter of the climate of the charging station in the region of the battery; and controlling the climate of the charging station in the region of the battery during the charging of the battery.

The method of the second aspect may allow more efficient charging and may provide a battery in a better condition for use after charging. The charging station may be a mobile charging station. Controlling the climate of the charging station in the region of the battery during the charging of the battery may use an automatic climate monitoring and adjusting system.

The climate parameters may include temperature and/or humidity of air inside the charging station.

Controlling the temperature may comprise raising the temperature and/or lowering the temperature. This may allow improved battery performance by preventing overheating and by avoiding a low output voltage due to cold temperatures. In general, this may allow improved heating in a wider range of environments.

The charging may take place indoors and/or outdoors. The method may further comprise moving the charging station between an indoor area and an outdoor area. This may allow batteries to be provided closer to a worksite as required by a user, avoiding wasted time retrieving batteries.

The method of the second aspect may be performed using the mobile battery charging and storage station of the first aspect.

### BRIEF DESCRIPTION OF THE DRAWINGS

Embodiments of the invention will now be described, by way of example only, with reference to the accompanying drawings, in which:

FIGS. 1a and 1b show front and rear perspective views of a mobile battery charging and storage station according to the invention in a first configuration.

FIG. 2 shows the mobile battery charging and storage station according to the invention in a second configuration.

FIG. 3 shows a cross-sectional view of the mobile battery charging and storage station according to the invention.

FIG. 4 shows an internal storage unit of the mobile battery charging and storage station according to the invention in isolation.

FIG. 5 shows a second mobile battery charging and storage station according to the invention.

FIG. 6 shows a second internal storage unit of the mobile battery charging and storage station according to the invention in isolation.

### DETAILED DESCRIPTION

The below description describes the mobile battery charging and storage station, which may be made portable and suitable for indoor and outdoor use. By providing such a portable battery charging and storage station, as more work tools transition to being battery powered, time on a worksite may be saved and batteries may be maintained in better condition.

To ensure that battery packs are charged efficiently and safely, the battery charging and storage station has an automatic climate monitoring and adjusting system 60 to monitor and adjust the climate, e.g. the temperature and/or humidity, in which the battery packs are stored and charged.

The battery charging and storage station may also have various failsafe mechanisms in order to improve the safety of the system.

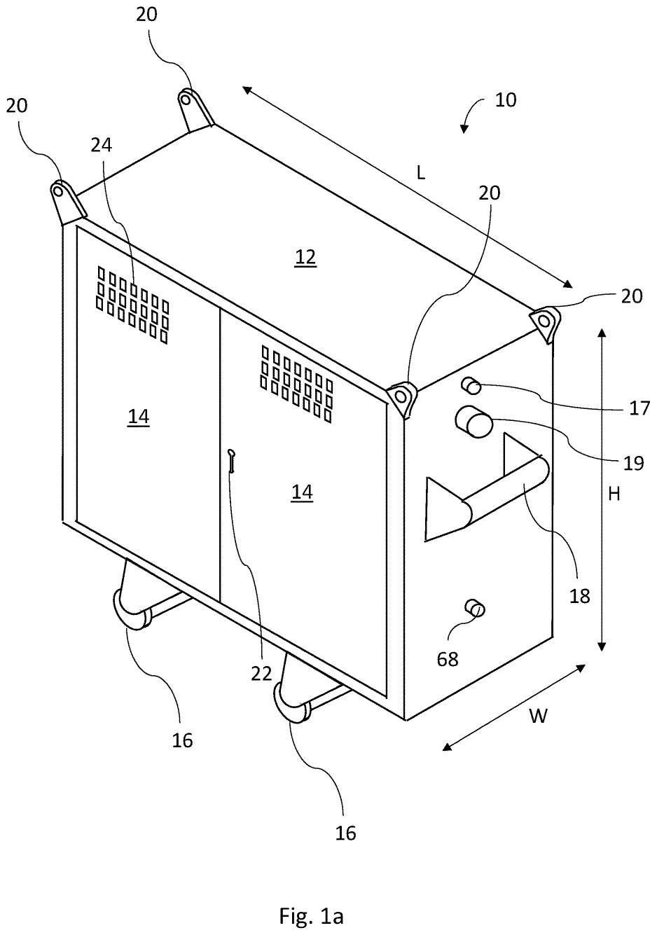

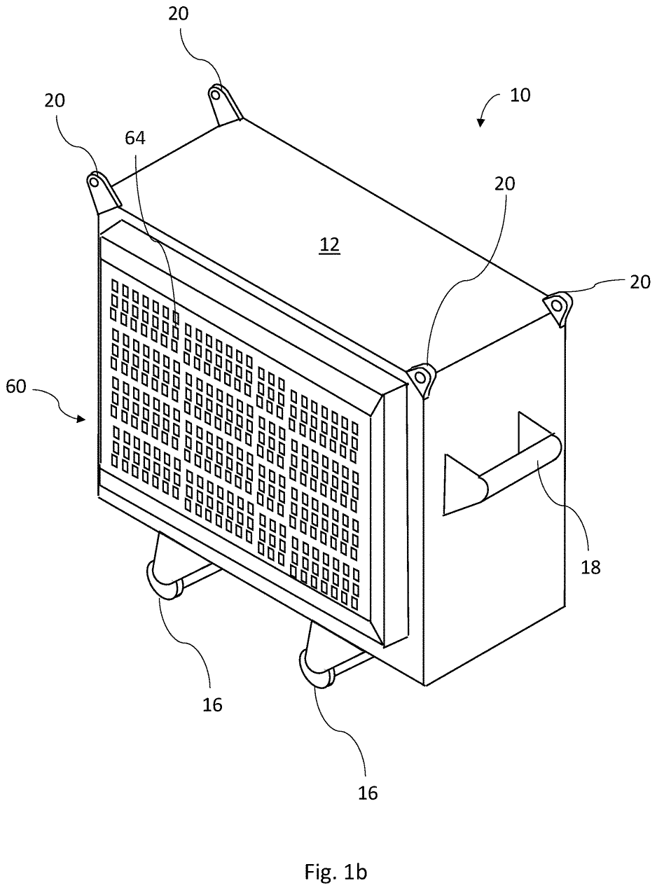

FIGS. 1a and 1b show a mobile battery charging and storage station 10 which may be used to store and charge battery packs, hereinafter referred to as the station.

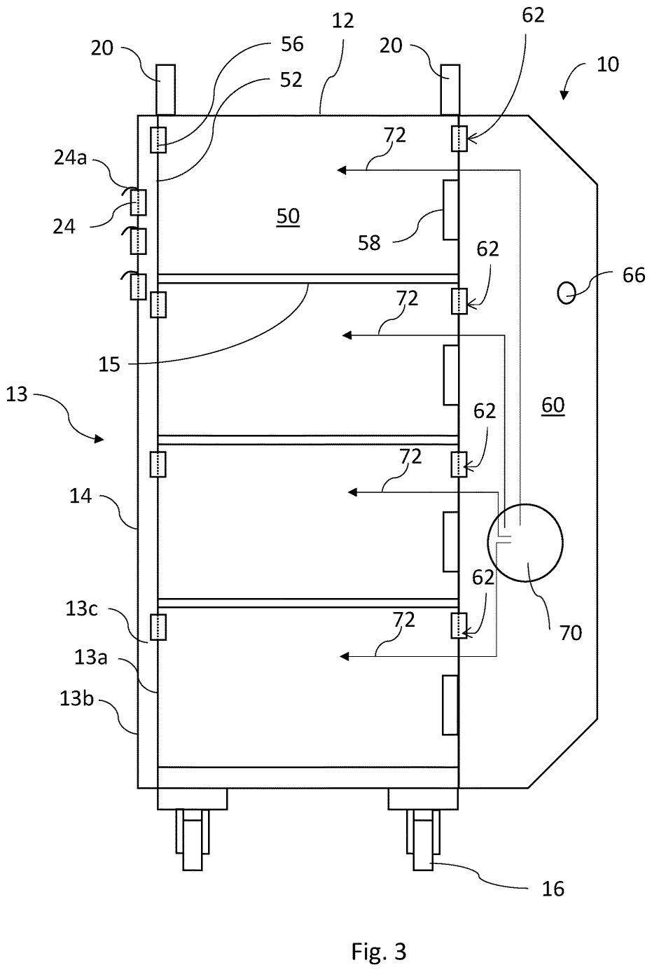

The station 10 may comprise a cabinet 13 having a width W, height H and length L, and may comprise one or more general closures 14, as well as a rigid outer case 12. The general closures 14 may each comprise at least one handle, not shown, which may be formed as an integral part of the closure and may be configured to be lockable to prevent access to the interior of the station 10. The general closures 14 may further comprise a general vent 24 for allowing airflow between the interior of the station 10 and the environment external to the cabinet. To make the station 10 suitable for use outdoors, the general vent 24 may have a rain cover 24a as shown in FIG. 3 for reducing the ingress of water into the general vent.

The cabinet may have a double wall arrangement comprising an inner wall 13a, an outer wall 13b and a cavity 13c between the inner and outer walls, and wherein the internal storage units 50 are arranged within the inner wall. Such an arrangement may improve insulation of the internal storage units 50 which may be beneficial for maintaining an optimum temperature for charging battery packs.

The general closure 14 may be lockable in order to prevent unauthorised access to the interior of the station 10. The general closure 14 may therefore have a lock 22. The lock 22 may be a key lock or may have a numerical keypad. The general closure 14 may prevent access to all of the internal storage units 50 of the station 10.

To make the station 10 portable, it may be mounted on a plurality of wheels 16. There may be four wheels 16 and the wheels may be aligned to allow movement in at least the lengthwise direction of the station 10 (i.e. along the major horizontal dimension of the cabinet). One or more of the wheels 16 may be a caster wheel and/or one or more of the wheels 16 may have a fixed direction of rotation. The station may also have brakes arranged to prevent rotation of one or more wheels when activated.

The station 10 may comprise at least one handle 18 mounted externally. The handle 18 may be formed as a cylindrical bar on an end of the station 10, as shown in FIGS. 1a and 1b. However, alternative handle arrangements may be fitted, such as handles on the sides or top of the station 10.

The station 10 may comprise at least one external mounting ring 20 suitable for fastening to a hook, such as a crane hook. In some cases, the station 10 may have four external mounting rings 20 in order to allow stable lifting by a crane. Additionally or alternatively, the station 10 may have fork lift slots, allowing the station 10 to be moved by a forklift truck.

The overall dimensions of the station 10 may be sized such that it can fit through a doorway measuring 800 mm wide by 1981 mm tall, hereinafter referred to as a standard doorway. The station 10 may therefore have a width W less than 800 mm. The station 10 may have a weight of less than 400 kg to further ensure that it may be moved by a single operator. The station weight may be less than 300 kg, may be less than 200 kg, or may be less than 100 kg.

The station 10 may comprise an externally mounted electrical connection 19 arranged to receive electrical power. The electrical connection 19 may also be referred to as a mains hook up socket. The electrical connection 19 may be arranged to receive electricity at a nominal voltage of 220-240 volts, and hence may operate using the UK and EU mains electricity supply and/or mains supply elsewhere in the world. The electrical connection 19 may be weatherproof and so may be arranged to engage with a corresponding plug such that the electrical conductors are not exposed to the outdoor environment. In particular, water ingress to the electrical conductors may be inhibited or prevented. The station 10 may have no fixed flying lead for connection to an external electrical power supply.

The station 10 may also comprise a general switch 17, which may be arranged to selectively prevent electrical communication between an external power source and the station 10. This may allow a shutoff to prevent electricity being supplied to the batteries and/or to the automatic climate monitoring and adjusting system 60 in the case of a malfunction.

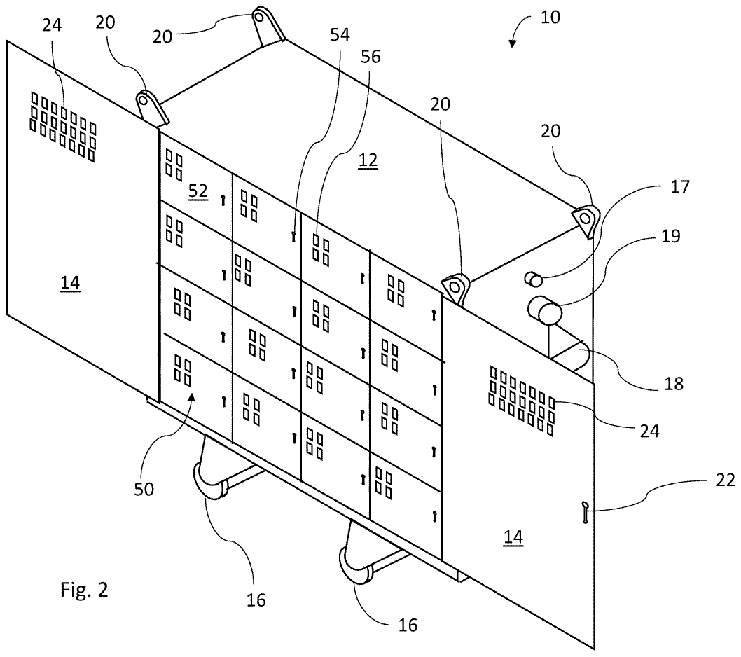

FIG. 2 shows the station 10 with the general closures 14 in an open arrangement. The station 10 has a plurality of internal storage units 50 within the station. Each internal storage unit may have a moveable closure 52 for selectively preventing access to the respective internal storage unit 50. The moveable closures 52 may each comprise at least one handle, not shown, which may be formed as an integral part of the closure, and each closure may be lockable to prevent access to the respective internal storage unit 50. Each closure may therefore have a lock 54. The moveable closures 52 may further comprise a closure vent 56 to allow a flow of air into and/or out of the internal storage unit 50 via the closure 52.

FIG. 3 shows a sectional view of the station 10. It can be seen that the internal storage units 50 are separated by walls 15. The walls 15 may be fireproof and may comprise a heat insulating material. In this way, if a battery malfunctions in one internal storage unit, the remaining batteries may be protected.

Each internal storage unit 50 has at least one electrical outlet 58 mounted within the internal storage unit, which may also be referred to as an internal mains power supply socket. The mains hook up socket 19 may be arranged to supply each of the internal mains power supply sockets 58 with electricity by forming an electrical circuit, and the electrical circuit may further comprise the general switch 17. The general switch 17 may be arranged to selectively allow electrical communication between the mains hook up socket 19 and all internal mains power supply sockets.

Each internal storage unit 50 may further comprise a unit air vent 62 positioned in one of the storage unit walls to allow air to flow into or out of the internal storage units 50 to/from the automatic climate monitoring and adjusting system 60. The automatic climate monitoring and adjusting system 60 may generally comprise a fan mounted to the rear of the cabinet with system air vent(s) 64 opening to ambient at the rear of the station, as shown in FIG. 1b.

The air supply flow direction to the storage units may be either from ambient or to ambient via the system air vent 64. Ambient air from external to the cabinet may be supplied into the internal storage units 50 via the general vent 24 and the closure air vent 24 under forced airflow action by the automatic climate monitoring and adjusting system. For example, the automatic climate monitoring and adjusting system 60 may comprise a fan to draw ambient air through the closure air vents 24 into internal storage units. Alternatively, air from the automatic climate monitoring adjusting system may be supplied into the internal storage units via unit air vent 62 and then exhausted to ambient from the general vent 24 via closure air vent 56.

By arranging each unit air vent 62 between a respective internal storage unit 50 and the automatic climate monitoring and adjusting system 60, air may flow directly to/from the automatic climate monitoring and adjusting system 60 into or out of an internal storage unit 50 via a unit air vent 62. This may allow improved control of the environment of the internal storage units.

Further, the combination of the unit air vents 62 and the closure air vents 56 may allow a throughflow of air through the internal storage units 50. This may allow further improved control of the environment of the internal storage units 50.

The general closure 14 may further be arranged to allow airflow between the plurality of internal storage units 50 and the environment, e.g. with ambient air flowing in from the environment external to the cabinet through the system air vent 64 and into the internal storage unit via unit air vent 62 and then out through the closure vent 56, and then through the general vent 24 to the environment.

In the illustrated arrangement, the fan of the automatic climate monitoring and adjusting system 60 draws ambient air through the internal storage units 50 via the general vent 24 and the closure air vent 56. The climate or environment within the internal storage units 50 is therefore adjusted according to the ambient environment external to the cabinet, which may cause heating or cooling or humidity adjustment, for example, of the air within the internal storage units 50. The air is then exhausted by the fan out via the unit air vent 62 and back to the external environment via system air vent 64.

The automatic climate monitoring and adjusting system 60 may alternatively supply air to the internal storage units 50 via their respective unit air vents 62. It may be beneficial to supply warm air to the internal storage units 50 for example when the station is used outdoors in cold temperatures to ensure the battery packs do not get too cold, or it may be beneficial to supply the internal storage units with cool air for example to ensure that the battery packs do not overheat when charging. As such, the automatic climate monitoring and adjusting system 60 may be arranged to selectively increase and/or decrease the temperature of the air supplied to the internal storage units 50 to optimise the temperature of the storage units for the charging of the battery packs therein. The automatic climate monitoring and adjusting system 60 may therefore have an electrical heating or cooling element in addition to the fan for heating and/or cooling the air before supplying this to the internal storage units 50.

The automatic climate monitoring and adjusting system 60 may further comprise at least one temperature and/or at least one humidity sensor 66 to sense the temperature and/or humidity inside the station 10. The sensor(s) may be communicatively coupled as part of the automatic climate monitoring and adjusting system 60 and/or to the general switch. Coupling the sensors to the automatic climate monitoring and adjusting system allows a closed loop control system to be formed, wherein temperature and/or humidity data may be fed back into the climate adjusting system. Coupling the sensors to the general switch may allow the switch to act as a failsafe mechanism, for example in the event that the temperature of the air inside the station 10 exceeds a safety limit, the general switch may be configured to open and prevent electrical communication between the mains hook up socket 19 and each internal mains power supply socket 58.

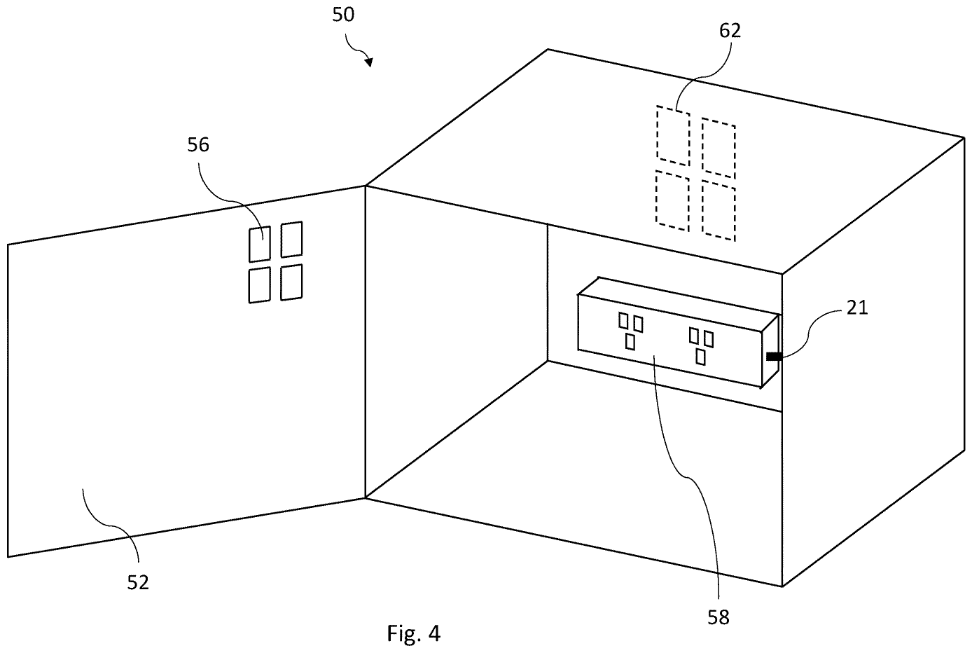

FIG. 4 shows a single internal storage unit 50 in isolation, with the moveable closure 52 in an open position. Each internal storage unit 50 may be sized to receive a battery pack which may be charged from an internal mains power supply socket 58. Each internal storage unit 50 may be sized to define an internal volume of at least 12000 cm³.

The battery pack may be for a power tool such as may be found on a construction or building site. The internal storage unit 50 may be sized to accommodate the battery pack attached to the power tool, or the battery pack alone detached from the remainder of the power tool.

Each internal storage unit 50 may further comprise at least one temperature sensor and/or at least one humidity sensor 66 arranged to sense the temperature and/or humidity of the air inside each internal storage unit. Either or both sensors may be communicatively coupled to the automatic climate monitoring and adjusting system 60 such that a closed loop control system is formed, wherein temperature and/or humidity data may be fed back into the climate adjusting system. The sensors may also or instead be communicatively coupled to the general switch to act as a failsafe mechanism, for example in the event that the temperature of the air inside an internal storage unit 50 exceeds a safety limit, the general switch may be configured to open and prevent electrical communication between the mains hook up socket 19 and each internal mains power supply socket.

The station 10 may further comprise failsafe mechanisms which may be operated automatically or manually. These may for example include circuit breakers designed to disconnect the electrical circuit in case of electrical overload, alarms which may be visual or auditory, fire suppression technology, or any combination thereof. The station may also comprise mechanical isolators 21 which may be used manually to disconnect the electrical supply from all or a portion of the electrical circuit for example for maintenance. For example, the station 10 may have a sounder 68, for example a buzzer or alarm, which may sound when the temperature of the air inside the station 10 exceeds (above or below) the safety limit. The sounder may continue to sound until the temperature of the air inside the station 10 exceeds recovers to be within the safe operating window within the safety limit.

The station 10 may be configured such that if the climate, for example the temperature or humidity, within one or more of the internal storage units 50 falls outside of a predetermined parameter range then the electrical power being supplied to the mains power supply socket or sockets 58 within the internal storage unit(s) 50 is cut and the sounder 68 sounds. In order to restart the supply of electrical power to the mains power supply socket or sockets 58 the general switch 17 must be reset. If the climate is still outside the range then the sounder 68 will continue to sound and the supply of electrical power to the mains power supply socket or sockets 58 will not continue until the climate recovers to within range.

As mentioned above, the internal storage units 50 are climate monitored by one or more sensors 66 of the automatic climate monitoring and adjusting system 60. If the automatic climate monitoring and adjusting system 60 determines that the temperature of the internal storage units 50 is too hot and falls outside of the predetermined temperature range, as described previously, then the electrical power being supplied to the mains power supply socket or sockets 58 within the internal storage unit(s) 50 is cut.

Cutting the power to the mains power supply socket or sockets 58, and therefore to any rechargeable batteries plugged onto those sockets 58 which generate heat when being recharged, should cause the temperature to fall back within range under normal recharging conditions. However, if the battery charging encounters a fault and the battery enters a thermal runaway state or even catches fire then cutting the power to the mains power supply socket or sockets 58 will be ineffectual at bringing the temperature of the internal storage units 50 back within range.

The station may therefore optionally include a fire suppression and/or extinguishing system 70. The system 70 may be configured to suppress and/or extinguish a fire within the cabinet 13. The fire suppression or extinguishing mechanism may be conventional.

The fire suppression and/or extinguishing system 70 may include one or more sensors for detecting if the temperature within one or more of the internal storage units 50 reaches a fire safety threshold temperature and/or the presence of a fire and trigger an action by the fire suppression and/or extinguishing system 70. For example, the action may be the delivery of an extinguishing vapour, e.g. via lines 72 as shown in FIG. 3, to deprive one or more of the internal storage units 50 of oxygen, thereby suppressing or extinguishing a fire or potential fire within the internal storage units 50. This is merely one example of an action by the fire suppression and/or extinguishing system 70 and other known actions for effectively suppressing or extinguishing a fire will may alternatively be employed by the fire suppression and/or extinguishing system 70. An alert may also be activated when the fire suppression and/or extinguishing system 70 is triggered.

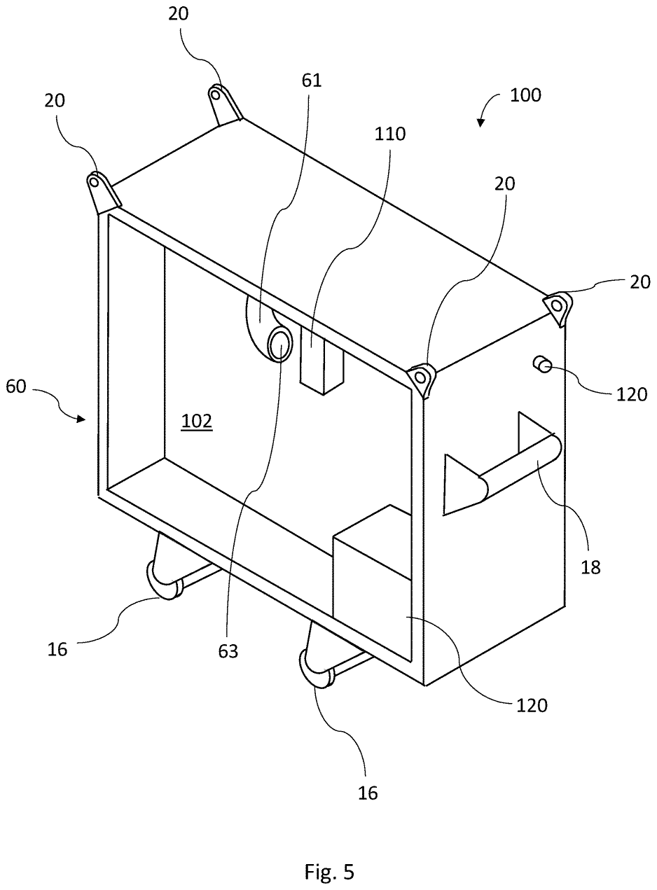

FIG. 5 shows a rear view of a second embodiment of the station 100 which comprises all of the features of the station 10. The automatic climate monitoring and adjustment system 60 has been omitted from FIG. 5 to show a rear portion of the internal structure of the station 100. The rear portion of the internal structure of the station 100 is shown as being separated from the rear of the internal storage units (not shown) by a solid wall 102. It will however be appreciated that the station 100 may in some cases be provided without a solid wall 102 separating the internal storage units from the rear portion. Each unit air vent 62 may be fluidically connected to the system vent 64 by a pipe system 61 comprising an outlet 63 adjacent the system vent 64. The outlet 63 may be accessible from an external port (not shown) of the station 100 such that the outlet 63 may be connected to, for example, a ventilation system of a building. Alternatively, the outlet 63 may be arranged to vent to the ambient via the system vent 64.

A smoke sensor 110 is provided adjacent the outlet 63 and is configured to sense the presence of smoke or gas at the outlet 63. In particular, the smoke sensor 110 is configured to sense the presence of smoke drawn from the internal storage units 50 by the automatic climate monitoring and adjusting system 60. The smoke sensor 110 may be gas sensor or a heat sensor. It may be preferable to use a smoke sensor that is not an optical sensor such that the station 100 is suitable for both indoor and outdoor use. An optical based sensor may be more likely to yield a false positive result, for example as a result of dust from an outdoor building site entering the station 100 via the system vent 64. The smoke sensor 110 may be part of the fire suppression/extinguishing system 70 or may be arranged to communicate with the fire suppression/extinguishing system.

By way of non-limiting example, the fire suppression/extinguishing system may be configured to terminate power supply to each of the internal storage units 50 should the smoke sensor 110 detect smoke.

The station 100 also comprises a reserve power supply 120 which may for example be a 12 volt battery. The reserve power supply 120 is arranged to supply electrical power to the station 100, in particular to the automatic climate monitoring and adjusting system 60, should the electrical power supply to the automatic climate monitoring and adjusting system 60 from the mains hook up socket 19 be disrupted. This may for example occur should a fire be detected within the cabinet 13 and electrical power supply to the station 100 and/or internal storage units 50 is cut. In this situation, the automatic climate monitoring system 60 is configured to use the electrical power supplied by the reserve power supply 120 to drive a fan or equivalent to draw air through and out of the internal storage units 50. This is in contrast to traditional charging station designs which seal any vents in the event of a fire to starve the fire of oxygen, which may detrimentally cause battery off gasses to build up and cause an explosion. Drawing air and other gases through and out of the internal storage units 50 in the event of a fire may reduce the likelihood of the pressure within the internal storage unit 50 and/or the cabinet 13 increasing beyond a threshold level which may cause the station 100 to breach. The fire detection may include a heat sensor, smoke sensor or the like. The fan maybe activated on the reserve power supply at temperatures within the station of above 70 degrees Celsius, for example.

The station 100 further comprises a wireless fire alarm connection 120. This may provide internal wireless connections between elements of a fire alarm system of the station 100, and may connect to the fire suppression/extinguishing system 70. The firm alarm system may include the a beacon and/or a light on the station and/or and the smoke sensor 110 described previously, and/or other fire alarm elements within the station such as a heat sensor. The wireless fire alarm may also provide an external wireless connection outside the station 100. The external wireless connection may connect to part of a site or building fire alarm system which may comprise sensors and/or alarms both indoors and outdoors about a site. The wireless fire alarm allows the station 100 to communicate with the site fire alarm system regardless of where the station 100 is located, making the station 100 suitable for use indoors, outdoors and for moving between the two. The wireless fire alarm may be configured to cut the electrical power supply to the station 100 in the event that the site fire alarm system determines a fault on site. Alternatively, should a fault be determined within the station, for example by the fire suppression/extinguishing system 70 being activated or by the smoke sensor 110 detecting smoke, the wireless fire alarm may be configured to communicate with the site fire alarm system to raise a site-wide alarm.

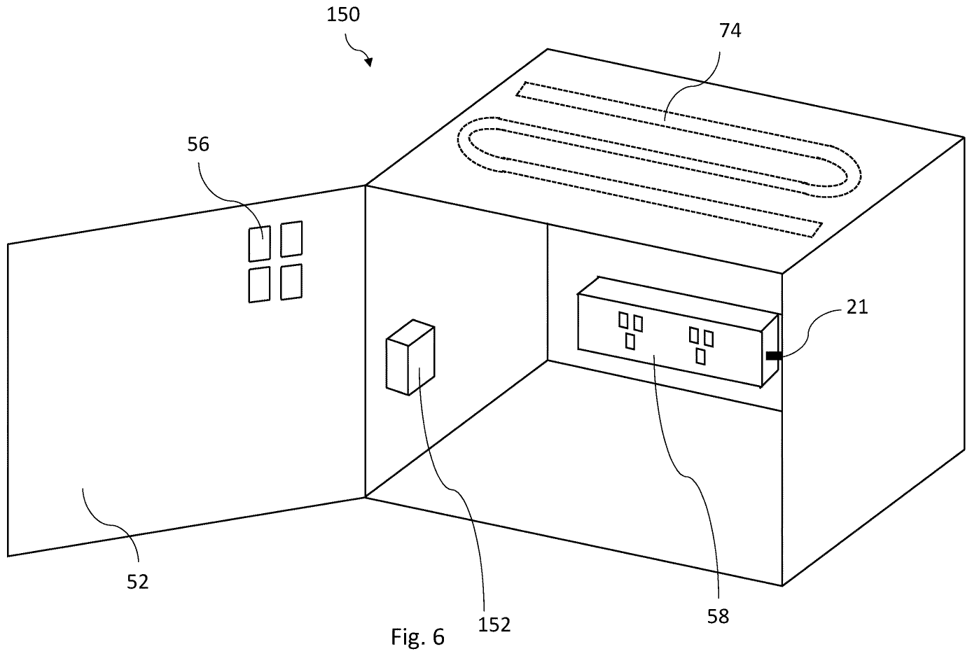

FIG. 6 shows a second internal storage unit 150. It will be appreciated that the second internal storage unit 150 shown in FIG. 6 is substantially similar to the internal storage unit 50 shown in FIG. 4 and as such may comprise all the features of the internal storage unit 50. For brevity, details of these features will not be repeated here and for clarity some of these features such as the unit air vent 62 have been omitted.

The second internal storage unit 150 comprises a global system for mobile (GSM) module 152. The GSM module 152 may be provided by any external supplier and is configured to wirelessly communicate with a mobile device such as a mobile phone to alert a user. The GSM module may be activated by, for example, the smoke sensor 110, the fire suppression/extinguishing system 70 or the wireless fire alarm described previously. That is to say that an alert may be communicated to a user's mobile phone should smoke be detected, should the temperature in the station 10, 100 exceed a predetermined threshold, or should a fire be detected. The station 10, 100 may comprise a single GSM module configured to alert a user should a fault be detected in any internal storage unit 50, 150. It may be convenient to provide the GSM module 152 in the internal storage unit 150 or as being accessible via the internal storage unit 152 such that an operator can easily access the GSM module 152, for example for maintenance.

Providing a GSM module 152 allows the station 10, 100 to be used both indoors and outdoors as it allows a user to be alerted regardless of where the station is located relative to the user, rather than relying on the static alarm system of a site.

Furthermore, the GSM module 152 can be set up to wirelessly communicate with a building's fire suppression and/or extinguishing system. Accordingly, when the station 10, 100 is situated within a building for indoor use, activation of the GSM module 152 by, for example, the smoke sensor 110, the fire suppression/extinguishing system 70 or the wireless fire alarm described previously, the GSM module 152 can trigger the building's fire suppression and/or extinguishing system directly to activate. The GSM module can store a unique identifier so the location of the GSM module within the building can be set up within the building's fire suppression and/or extinguishing system. If there are several of the stations 10, 100, each with their own GSM module 152 having their unique identifier, then each GSM module 152 can be separately connected to the building's fire suppression and/or extinguishing system, and the location of each station 10, 100 can be set up within the building's fire suppression and/or extinguishing system.

The second internal storage unit 152 also comprises a direct low pressure (DLP) fire suppression/extinguishing system 74 shown schematically as a hidden detail in FIG. 6. The DLP fire suppression/extinguishing system 74 is part of the fire suppression/extinguishing system 70. The DLP fire suppression/extinguishing system 74 may be connected to the lines 72 described previously with reference to FIG. 3, and as such may house an extinguishing vapour. The DLP fire suppression/extinguishing system 74 is arranged to breach should the temperature in the internal storage unit 150 exceed a predetermined threshold or should a flame come into close contact with the DLP fire suppression/extinguishing system 74. Once the DLP fire suppression/extinguishing system 74 has breached the extinguishing vapour housed therein is released into the internal storage unit 150 to extinguish any flames in the storage unit. The fire suppression/extinguishing system 70 may further comprise sensors (not shown) to determine when the DLP fire suppression/extinguishing system 74 has been activated. Based on this, alarms may be raised by the GSM alarm 152, the wireless fire alarm, or the alert described previously. The DLP fire suppression/extinguishing system 74 is a wet fire suppression and may discharge foam which extracts heat from any fire source, and the foam is retained in a sump within the cabinet to minimise environmental impact which is suitable for both indoor and outdoor use. The DLP fire suppression/extinguishing system 74 may be configured as an analogue, pressure valve, burst hose system which runs through the internal storage units 150, and does not require charging or electrical power supply.

Although the invention has been described above with reference to one or more preferred embodiments, it will be appreciated that various changes or modifications may be made without departing from the scope of the invention as defined in the appended claims.

1. A mobile battery charging and storage station for both indoor and outdoor use, comprising:
a weatherproof, secure cabinet mounted on wheels and having a width of less than 800 mm,
a plurality of internal storage units within the cabinet, each having an internal mains power supply socket and a unit air vent, each storage unit sized to receive a battery pack to be charged from the power supply socket,
wherein the cabinet has an externally mounted weatherproof mains hook up socket electrically connected to supply each of the internal mains power supply sockets, and
wherein the cabinet houses an automatic climate monitoring and adjusting system for supplying air to the storage units via their respective unit air vents to optimise the climate of the storage units for the charging of batteries therein.

2. The mobile battery charging and storage station of claim 1, wherein each of the internal storage units has a moveable closure for selectively preventing access to the respective internal storage unit.

3. The mobile battery charging and storage station of claim 2, wherein each closure has a closure vent to allow a throughflow of air via the unit air vent, the internal storage unit and the closure vent.

4. The mobile battery charging and storage station of claim 3, wherein the automatic climate monitoring and adjusting system has a fan for drawing ambient air through the internal storage units in parallel.

5. The mobile battery charging and storage station of claim 4, comprising a smoke sensor adjacent an exhaust from the fan for detecting smoke from within any one of the internal storage units.

6. The mobile battery charging and storage station of claim 2, wherein each closure is lockable.

7. The mobile battery charging and storage station of claim 1, the cabinet further comprising a general closure, the general closure arranged to prevent access to all of the internal storage units.

8. The mobile battery charging and storage station of claim 7, wherein the general closure further comprises a general vent for allowing airflow between the plurality of internal storage units and the environment external to the cabinet.

9. (canceled)

10. The mobile battery charging and storage station of claim 1, further comprising a general switch arranged to selectively allow electrical communication between the mains hook up socket and the power supply sockets of the internal storage units.

11. The mobile battery charging and storage station of claim 10, further comprising a reserve power supply coupled to the automatic climate monitoring and adjusting system, wherein the general switch is configured to isolate power to the power supply sockets of the internal storage units, and/or the reserve power supply is configured to activate a fan of the automatic climate monitoring and adjusting system to draw ambient air through the internal storage units, when a fire is detected within the mobile battery charging and storage station.

12. The mobile battery charging and storage station of claim 1, wherein the automatic climate monitoring and adjusting system is arranged to selectively increase or decrease the temperature of the air in the storage units.

13. (canceled)

14. The mobile battery charging and storage station of claim 1, wherein the station has a weight of less than 400 kg.

15. (canceled)

16. The mobile battery charging and storage station of claim 1, further comprising at least one temperature sensor and/or at least one humidity sensor arranged to sense temperature and/or humidity inside the station.

17. The mobile battery charging and storage station of claim 16, wherein the at least one temperature sensor and/or at least one humidity sensor are communicatively coupled to the automatic climate monitoring and adjusting system and/or to the general switch.

18. The mobile battery charging and storage station of claim 16, comprising one or more temperature and/or humidity sensors, the temperature and/or humidity sensors being arranged to sense temperature and/or humidity in the cabinet and/or in each internal storage unit directly.

19. The mobile battery charging and storage station of claim 1 further comprising an electrical isolator switch arranged to selectively prevent electrical communication between the mains hook up socket and the power supply sockets of the internal storage units.

20. The mobile battery charging and storage station of claim 1, further comprising a sounder for sounding when the climate of the storage units exceeds predetermined limits.

21. The mobile battery charging and storage station of claim 1, wherein the cabinet further comprises a double wall arrangement comprising an inner wall, an outer wall and a cavity between the inner and outer walls, and wherein the internal storage units are arranged within the inner wall.

22. The mobile battery charging and storage station of claim 1, further comprising a fire suppression and/or extinguishing system.

23. The mobile battery charging and storage station of claim 1 further comprising a global system for mobile, GSM, module for communicating with a building's fire suppression and/or extinguishing system so as to activate the building fire suppression and/or extinguishing system when the GSM module is activated, such as upon detection of a fire within the mobile battery charging and storage station.

24-29. (canceled)
